(19) United States
(12) Patent Application Publication
(10) Pub. No.: US 2024/0333542 A1
(43) Pub. Date: Oct. 3, 2024

(54) CONFERENCE SUPPORT SYSTEM AND CONFERENCE SUPPORT METHOD

(71) Applicant: HONDA MOTOR CO., LTD., Tokyo (JP)

(72) Inventor: Hajime Yokoyama, Tokyo (JP)

(21) Appl. No.: 18/444,631

(22) Filed: Feb. 17, 2024

(30) Foreign Application Priority Data
Mar. 28, 2023 (JP) 2023-052018

(51) Int. Cl. H04L 12/18

(52) U.S. Cl. CPC H04L 12/1813

(57) ABSTRACT

A conference support system includes: a detection unit configured to detect that a plurality of occupants riding in a same moving object is participating in a same online conference; a generation unit configured to generate an interior image indicating that the plurality of occupants is present in a same interior space of the moving object; and a transmission unit configured to transmit the interior image to a terminal device of a conference participant participating in the online conference.

### INCORPORATION BY REFERENCE

The present application claims priority under 35 U.S.C. § 119 to Japanese Patent Application No. 2023-052018 filed on Mar. 28, 2023. The content of the application is incorporated herein by reference in its entirety.

### BACKGROUND OF THE INVENTION

### Field of the Invention

The present invention relates to a conference support system and a conference support method.

### Description of the Related Art

In recent years, an approach of providing access to a sustainable transportation system considering even vulnerable people like the elderly, people with disabilities, and children, among traffic participants is gaining momentum. Towards the realization, the focus is on research and development for further improving traffic safety and convenience through development regarding comfortability of vehicles.

Japanese Patent Laid-Open No. 2022-129626 discloses an in-vehicle terminal device which is loaded in a vehicle and configures an electronic conference system. In the in-vehicle terminal device, according to a state of the vehicle, output or non-output of an opposite side voice signal from a speaker inside the vehicle is switched and transmission or non-transmission of a vehicle side voice signal to an opposite side terminal device is switched.

Japanese Patent Laid-Open No. 2005-333226 discloses a video conference system for vehicles, which makes it possible to recognize current positions of conference participants moving in vehicles. In the video conference system, a controller of the vehicle that the conference participant is riding transmits the current position of the present vehicle to the other vehicles that the other conference participants are riding. The controllers of the other vehicles display the position of each vehicle of the other conference participant on a map screen of a display device, and displays a moving image of the above other conference participant in association with the riding vehicle of the participant on a participant display screen next to the map screen.

Now, for comfortability of vehicles, when an occupant of a vehicle participates in an online conference from the vehicle, a problem is to make other participants outside the vehicle recognize that the other participant participating in the same online conference is present in the vehicle and whether the participant is a driver or a passenger, so as to improve quality of communication.

In order to solve the above-described problem, an object of the present application is to enable other participants outside a moving object to recognize that a plurality of conference participants is participating in an online conference from the same moving object and a situation of the plurality of participants inside the moving object or the like and improve quality of communication, thereby contributing to development of a sustainable transportation system.

### SUMMARY OF THE INVENTION

One mode of the present invention aspect is a conference support system including: a detection unit configured to detect that a plurality of occupants riding in a same moving object is participating in a same online conference; a generation unit configured to generate an interior image indicating that the plurality of occupants is present in a same interior space of the moving object; and a transmission unit configured to transmit the interior image to a terminal device of a conference participant participating in the online conference.

According to another mode of the present invention aspect, the generation unit generates the interior image by superimposing an occupant display indicating each of the plurality of occupants on an interior space image indicating the interior space of the moving object.

According to a further mode of the present invention aspect, the detection unit specifies a position, in an interior of the moving object, of each of the plurality of occupants attending the online conference, and the generation unit generates the interior image by superimposing the occupant display indicating the occupant at the position corresponding to each of the plurality of occupants on the interior space image indicating the interior space of the moving object.

According to a still further mode of the present invention aspect, the detection unit specifies an attribute of the moving object including a kind, a model, a seating capacity or a seat arrangement of the moving object, and the generation unit determines the interior space image to be used for the interior image based on the attribute of the moving object.

According to a yet further mode of the present invention aspect, the occupant display superimposed on the interior image is an icon or an image indicating a corresponding occupant.

According to a yet still further mode of the present invention aspect, the detection unit determines a plurality of persons participating in the online conference from each of terminal devices loaded in the moving object as the plurality of occupants participating in the online conference from the moving object.

According to a yet still further mode of the present invention aspect, the detection unit acquires a current position of the moving object and a current position of each of terminal devices used for the online conference at a predetermined time interval, and determines persons who participate in the online conference using the terminal devices indicating a same position change as the moving object within a predetermined position error range as the plurality of occupants participating in the online conference from the moving object.

According to a yet still further mode of the present invention aspect, the detection unit acquires acceleration of the moving object and acceleration of each of terminal devices used for the online conference at a predetermined time interval, and determines persons who participate in the online conference using the terminal devices indicating a same acceleration change as the moving object within a predetermined error range as the plurality of occupants participating in the online conference from the moving object.

According to a yet still further mode of the present invention aspect, the detection unit detects the plurality of occupants who participates in the online conference from the moving object, based on an image from a camera which is loaded in the moving object and which photographs an interior of the moving object.

According to a yet still further mode of the present invention aspect, the detection unit acquires, from a terminal device of a person who participates in the online conference, information on the moving object that the person is riding when participating in the online conference.

A yet still further mode of the present invention aspect is a conference support method performed by a computer provided in a conference support system, and the method includes: a detection step of detecting that a plurality of occupants riding in a same moving object is participating in a same online conference; a generation step of generating an interior image indicating that the plurality of occupants is present in a same interior space of the moving object; and a transmission step of transmitting the interior image to a terminal device of a conference participant participating in the online conference.

According to the aspect of the present invention aspect, a situation inside a moving object of a plurality of conference participants who participate in a same online conference from the same moving object or the like can be reported to the other conference participants outside the moving object, thereby contributing to improvement of quality of communication among the conference participants.

### BRIEF DESCRIPTION OF THE DRAWINGS

FIG. 1 is a diagram illustrating a configuration of a conference support system according to one embodiment of the present invention;

FIG. 2 is a diagram illustrating a configuration of a conference server configuring the conference support system;

FIG. 3 is a diagram illustrating a configuration of a portable terminal configuring the conference support system;

FIG. 4 is a diagram illustrating a configuration of a mobile terminal device configuring the conference support system;

FIG. 5 is a diagram illustrating an example of an interior image displayed at a terminal device of a conference participant;

FIG. 6 is a diagram illustrating another example of the interior image displayed at the terminal device of the conference participant;

FIG. 7 is a diagram illustrating a yet another example of the interior image displayed at the terminal device of the conference participant; and

FIG. 8 is a flowchart illustrating a procedure of an operation of the conference support system.

### DETAILED DESCRIPTION OF THE PREFERRED EMBODIMENTS

### [1. Embodiment]

Hereinafter, the embodiment of the present invention will be explained with reference to the drawings.

### [1.1 Configuration of Conference Support System]

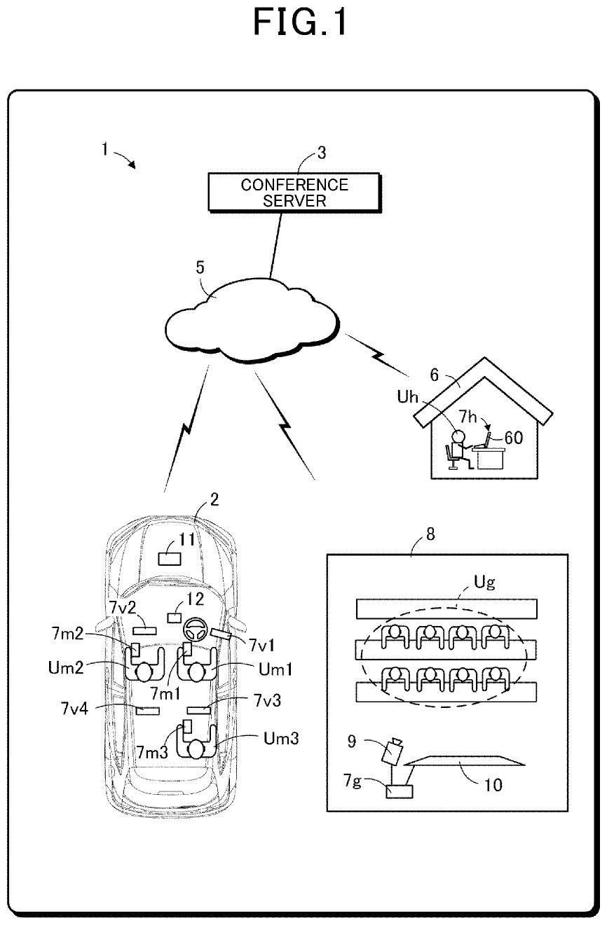

FIG. 1 is a diagram illustrating a configuration of a conference support system 1 according to one embodiment of the present invention. The conference support system 1 detects a plurality of conference participants who participate in a same online conference from a same moving object 2, and presents a situation and the like in an interior of the moving object 2 of the plurality of conference participants to the other participants outside the moving object 2.

The moving object 2 is a vehicle, for example, in the present embodiment. Yet, the moving object 2 is not limited to the vehicle and may be an arbitrary moving object which includes a cabin (passenger compartment) where occupants get on to enable multiple people to get on. Such a moving object may be, in addition to a land moving object such as a passenger car, a bus and a taxi, a marine moving object such as a ship and a submarine, an air moving object such as an aircraft including an eVTOL (Electric Vertical Take-Off and Landing aircraft) and an airship, or a space moving object such as a spacecraft and an artificial satellite.

The conference support system 1 includes a conference server 3 which provides functions of the online conference, and portable terminals 7m1, 7m2 and 7m3 used by conference participants Um1, Um2 and Um3 who participate in the online conference. The portable terminals 7m1, 7m2 and 7m3 are, for example, smartphones. The conference server 3 and the portable terminals 7m1, 7m2 and 7m3 are communicably connected via a communication network 5. In an example illustrated in FIG. 1, the conference participants Um1, Um2 and Um3 are riding in the moving object 2 carrying the portable terminals 7m1, 7m2 and 7m3, respectively. Here, the conference participant Um1 is a driver of the moving object 2.

In addition, the conference support system 1 may include, as terminal devices of the conference participants, for example, a terminal device 7h of a conference participant Uh who participates in the online conference from a house 6 for home teleworking and/or a terminal device 7g utilized in common at a conference location 8 such as an office conference room of a company by a participant group Ug participating in the online conference from the conference location. The terminal device 7h is a laptop PC including a display device 60, for example. Further, the terminal device 7g photographs the participant group Ug at the conference location by a camera 9, and displays information to the participant group Ug by a display device 10. The terminal devices 7h and 7g are communicably connected with the conference server 3 via the communication network 5.

The conference support system 1 may include an information provision device 11 provided in the moving object 2, further. The information provision device 11 includes a computer, and transmits information on an attribute (to be described later) of the moving object 2, information on a current position and acceleration of the moving object 2, and an image of the interior of the moving object 2 photographed by a camera 12 provided in the moving object 2, to the conference server 3, by a request from the conference server 3.

Further, the conference support system 1 may include mobile terminal devices 7v1, 7v2, 7v3, and 7v4 provided in the moving object 2. The conference participants who are occupants of the moving object 2 can participate in the online conference by using the mobile terminal devices 7v1, 7v2, 7v3, and 7v4. For example, the conference participants Um1, Um2 and Um3 can participate in the online conference by using the mobile terminal devices 7v1, 7v2, and 7v3 instead of the portable terminals 7m1, 7m2 and 7m3.

The information provision device 11 and the mobile terminal devices 7v1, 7v2, 7v3, and 7v4 are communicably connected with the communication network 5 via a third communication device 51 (to be described later) provided in the moving object 2.

Hereinafter, the conference participants Um1, Um2 and Um3 who participate in the online conference from the moving object 2 by using the portable terminals 7m1, 7m2 and 7m3 or the mobile terminal devices 7v1, 7v2, 7v3, and 7v4 are generically called mobile participants Um as well. In addition, the mobile participants Um, and the conference participant Uh and each conference participant included in the participant group Ug who are the other conference participants are generically called conference participants U.

Further, the portable terminals 7m1, 7m2 and 7m3 are generically called portable terminals 7m as well, and mobile terminal devices 7v1, 7v2, 7v3, and 7v4 are generically called mobile terminal devices 7v as well. In addition, the portable terminals 7m, the mobile terminal devices 7v and the terminal devices 7h and 7g are generically called terminal devices 7 as well.

Further, hereinafter, for each of the conference participants included in the participant group Ug, the terminal device 7 used by the conference participant U is the terminal device 7g used in common by the conference participants.

Configurations of the conference server 3, the portable terminal 7m and the mobile terminal device 7v will be successively explained below.

Note that the terminal devices 7h and 7g log in to the online conference using setting information for the online conference to be described later in response to an operation of the corresponding conference participant U, by a software program required for the online conference being executed according to prior art. In addition, after the above login, the terminal devices 7h and 7g perform transfer of voice, transfer of conference material data and/or transfer of images or the like which are predetermined conference operations required for the online conference with the conference server 3 using a microphone, a speaker, an input device such as a keyboard, and a display device (the display device 10 in a case of the terminal device 7g) which are provided in the terminal devices 7h and 7g and are not illustrated, according to the prior art. The images displayed at the above display device may include an image of a participant display distributed by the conference server 3 to be described later.

### [1.2 Configuration of Conference Server]

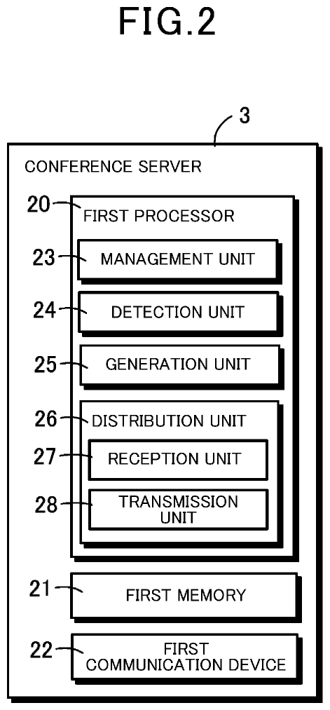

FIG. 2 is a diagram illustrating the configuration of the conference server 3.

The conference server 3 includes a first processor 20, a first memory 21, and a first communication device 22. The first memory 21 is configured, for example, by a volatile and/or nonvolatile semiconductor memory, and/or a hard disk device or the like. The first communication device 22 is a transmitter/receiver for the conference server 3 to wirelessly communicate with an external device via the communication network 5. The external device may include a conference server which supports holding of an online conference according to the prior art, for example.

The first processor 20 is a computer including a CPU or the like, for example. The first processor 20 may include a ROM in which a program is written, and a RAM for temporary storage of data, or the like. Then, the first processor 20 includes a management unit 23, a detection unit 24, a generation unit 25, and a distribution unit 26, as functional elements or functional units. The distribution unit 26 includes a reception unit 27 and a transmission unit 28 as the functional elements or the functional units.

The functional elements provided in the first processor 20 are realized by the first processor 20 which is the computer executing a program preserved in the first memory 21, for example. Note that the program can be stored in a computer-readable arbitrary storage medium. Instead, all or a part of the above functional elements provided in the first processor 20 can be also configured by hardware including one or more electronic circuit components, respectively.

The management unit 23 receives a conference setting request for an online conference via an arbitrary terminal device from a conference organizer of the online conference. The conference setting request includes holding date and time, mail addresses of persons to be invited as conference participants, and/or a mail address of a conference location.

The management unit 23 stores a received holding notice and transmits conference setting information for the online conference to the terminal device of the conference organizer, according to the prior art. The conference setting information includes login information to the above set online conference. The conference organizer transmits a conference holding notice including the above conference setting information to the mail addresses of invitees to the online conference and/or the conference location.

In addition, when a login request using the above setting information is received from one of the terminal devices, the management unit 23 transmits information on the conference participant who has transmitted the above login request to the terminal device of the conference organizer, according to the prior art. When a login permission for the above conference participant U is received from the conference organizer via the terminal device, the management unit 23 permits the distribution unit 26 to be described later to transmit and receive information on the online conference to/from the terminal device of the conference participant who has transmitted the login request.

In the present embodiment, in particular, the setting request transmitted to the conference server 3 by the conference organizer includes access information for a moving object scheduled to be utilized by one of the conference participants at the holding date and time of the online conference. In addition to the access information for the moving object, the conference setting request may include identification information (for example, a vehicle number) of the moving object linked with the above access information. For example, in the present embodiment, the conference participant Um1 becomes the conference organizer and transmits the conference setting request for the online conference to the conference server 3 by the portable terminal 7m1. The conference setting request includes the access information for the moving object 2 scheduled to be utilized by the conference participant Um1 at the holding date and time of the online conference, and the identification information for the moving object 2.

The detection unit 24 detects that a plurality of occupants riding in the same moving object is participating in the same online conference.

For example, the detection unit 24 acquires, from the terminal device of the person who participates in the online conference, information on the moving object that the person is riding when participating in the above online conference.

Specifically, for example, the mobile participant Um transmits the login request including the information on the moving object 2 that he/she is riding (for example, the identification information for the moving object 2) to the conference server 3 when logging in to the online conference by activating a conference participation app (to be described later) for the online conference in the portable terminal 7m or the mobile terminal device 7v. The detection unit 24 receives the above login information, and determines that the mobile participant Um who has transmitted the login request including the same information as the information on the above moving object 2 is the conference participant riding together in the same moving object 2.

Alternatively, the detection unit 24 acquires a current position or acceleration of the moving object and a current position or acceleration of each of the terminal devices used for the online conference by the conference participants at a predetermined time interval, for example. Then, the detection unit 24 may determine that persons who participate in the online conference using the terminal devices indicating a same position change or acceleration change as the above moving object within a predetermined error range are the plurality of occupants participating in the online conference from the above moving object.

Specifically, for example, the detection unit 24 communicates with the information provision device 11 of the moving object 2 using the access information for the moving object 2 included in the conference setting request, and acquires the information on the current position or acceleration of the moving object 2 at the predetermined time interval. In addition, after the mobile participant Um logs in to the online conference by activating the conference participation app for the online conference in the portable terminal 7m, the detection unit 24 acquires the information on the current position or acceleration of the portable terminal 7m from the portable terminal 7m through the conference participation app at the predetermined time interval. The detection unit 24 can determine that the mobile participants Um who participate in the online conference using the portable terminals 7m indicating the same position change or acceleration change as the moving object 2 within the predetermined error range are the plurality of occupants participating in the online conference from the above moving object 2.

Further, alternatively, the detection unit 24 may determine that the plurality of persons participating in the online conference from each of the terminal devices loaded in the moving object is the plurality of occupants participating in the online conference from the moving object.

Specifically, for example, when the mobile participant Um logs in to the online conference by activating the conference participation app for the online conference in the mobile terminal device 7v loaded in the moving object 2, the detection unit 24 can determine that the mobile participant Um who has logged in using the mobile terminal device 7v is the occupant participating in the online conference from the moving object 2. The mobile terminal device 7v can include the information on the moving object 2 including the mobile terminal device 7v (for example, the identification information for the moving object 2) in the login request transmitted to the conference server 3, for example.

Further, alternatively, based on the image from the camera 12 which is loaded in the moving object 2 and which photographs the interior of the moving object 2, the detection unit 24 may determine that the occupant of the moving object 2 projected in the image is the occupant who participates in the online conference from the moving object 2. In this case, for example, the conference setting request received by the management unit 23 can include face images of the invitees to the online conference. For example, the detection unit 24 can use the face images included in the conference setting request as reference images and identifies the mobile participant Um from the face image of the person projected in the image acquired from the camera 12 of the moving object 2.

In addition, the detection unit 24 may specify a position, in the interior of the moving object, of each of the plurality of occupants attending the online conference from the moving object.

For example, based on the image from the camera 12 which is loaded in the moving object 2 and which photographs the interior of the moving object 2, the detection unit 24 specifies seat positions in the interior of the moving object 2, of the mobile participants Um who are the plurality of occupants attending the online conference from the moving object 2.

Alternatively, for the plurality of occupants participating in the online conference using the terminal devices loaded in the moving object, the detection unit 24 may specify the position of each occupant in the interior of the above moving object from an arrangement in the above moving object of the above terminal device used by each occupant.

Specifically, for example, when the mobile participant Um logs in to the online conference by activating the conference participation app for the online conference in the mobile terminal device 7v loaded in the moving object 2, the detection unit 24 specifies the seat position, in the interior of the moving object 2, of the mobile participant Um who has logged in, from the arrangement in the interior of the moving object 2 of the mobile terminal device 7v used for the login.

Further, when the plurality of occupants of the moving object participate in the online conference from the moving object, the detection unit 24 may specify an attribute of the moving object including a kind, a model, a seating capacity or a seat arrangement of the moving object. For example, the detection unit 24 can communicate with the information provision device 11 of the moving object 2, and acquire information on the attribute of the moving object 2 including the kind, the model, the seating capacity or the seat arrangement of the moving object 2 from the information provision device 11.

When the plurality of occupants of the moving object is participating in the online conference, the generation unit 25 generates an interior image indicating that they are in a same interior space of the moving object. The generated interior image is sent to the distribution unit 26 to be described later, and is distributed to the terminal device of each conference participant participating in the online conference.

For example, the generation unit 25 generates the above interior image by superimposing an occupant display indicating each of the plurality of occupants who participates in the online conference from the moving object on an interior space image indicating the interior space of the moving object. The above occupant display can be an icon to which a name of the occupant who is the conference participant is attached, or a face image of the occupant. For example, the generation unit 25 may acquire the image of the interior of the moving object 2 from the information provision device 11 of the moving object 2 and use the face image of the occupant extracted from the image as the occupant display.

The generation unit 25 generates the above interior image by superimposing the occupant display indicating the occupant at a corresponding position (for example, the seat position) of each of the plurality of occupants who is the conference participants on the interior space image indicating the interior space of the moving object.

In addition, when generating the interior image, the generation unit 25 can determine the above interior space image to be used for the above interior image based on the attribute of the moving object specified by the detection unit 24. For example, from various interior space images preserved in the first memory 21 beforehand in association with the various attributes of the moving object, the generation unit 25 can select and use one interior space image associated with the attribute of the moving object 2 specified by the detection unit 24.

Examples of the interior image that the generation unit 25 generates will be described later.

The distribution unit 26 includes the reception unit 27 and the transmission unit 28, and performs an online conference operation according to a permission from the management unit 23 described above, according to the prior art. That is, the distribution unit 26 communicates with the terminal device used by each conference participant of the online conference, and makes it possible to share the voice and/or the images (including text and moving images) among the conference participants. The shared voice includes the voice of the conference participants, and the shared images include, in addition to the images of materials for sharing transmitted from the conference participants, a participant display indicating the conference participants participating in the conference.

In the present embodiment, in particular, when the plurality of persons is participating in the online conference from the moving object, the transmission unit 28 of the distribution unit 26 transmits the participant display including the interior image generated by the generation unit 25 to the terminal device 7 of each conference participant U.

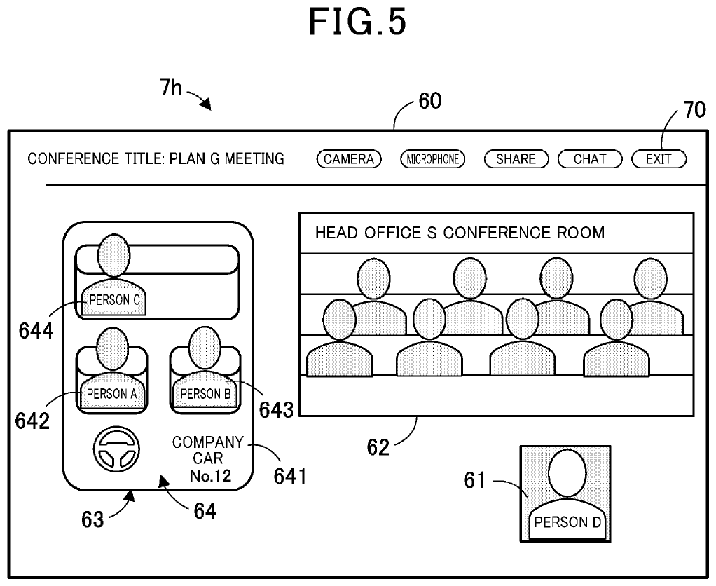

FIG. 5 is a diagram illustrating a first example of the interior image distributed by the distribution unit 26. FIG. 5 is, for example, an online conference screen displayed on the display device 60 of the terminal device 7h of the conference participant Uh. Note that the similar online conference screen is displayed also on the corresponding display devices (for example, the display device 10 and a first touch panel 33 and a second touch panel 42 to be described later) of the terminal devices 7 used by the other conference participants U.

On the online conference screen, a conference title and some operation buttons including an exit button 70 are displayed at a top part in the figure. The exit button 70 is a button for transmitting a logoff request from the online conference to the conference server 3.

Then, at a part below the display of the conference title or the like in the figure, the participant display distributed from the distribution unit 26 is displayed. In the example illustrated in FIG. 5, at a lower right of the display device 60 in the figure, a first participant display 61 indicating the conference participant Uh participating in the conference using this terminal device 7h is displayed. In addition, on a right side of the display device 60 in the figure, a second participant display 62 indicating each conference participant of the participant group Ug is displayed. For the second participant display 62, for example, a video image itself of the interior of the conference location 8 photographed by the camera 9 can be displayed.

Then, on a left side of the display device 60 in the figure, a third participant display 63 including the interior image generated by the generation unit 25 is displayed. For the third participant display 63 illustrated in FIG. 5, an interior image 64 which is the first example of the interior image is displayed.

In the interior image 64, a line drawing illustrating the interior of the moving object corresponding to an attribute “a 5-seater passenger car” of the moving object 2 is used as an interior space image 641, and occupant displays 642, 643 and 644 indicating each of the three mobile participants Um who are the occupants of the moving object 2 are superimposed and displayed at the corresponding positions of the respective mobile participants Um in the interior of the moving object 2. Specifically, the occupant displays 642, 643 and 644 correspond to the conference participants Um1, Um2 and Um3 illustrated in FIG. 1, respectively.

Here, the detection unit 24 of the conference server 3 detects or acquires the attribute of the moving object 2, the mobile participants Um who participate in the online conference from the moving object 2, and the arrangement of the mobile participants Um in the interior of the moving object 2, by one of the operations described above.

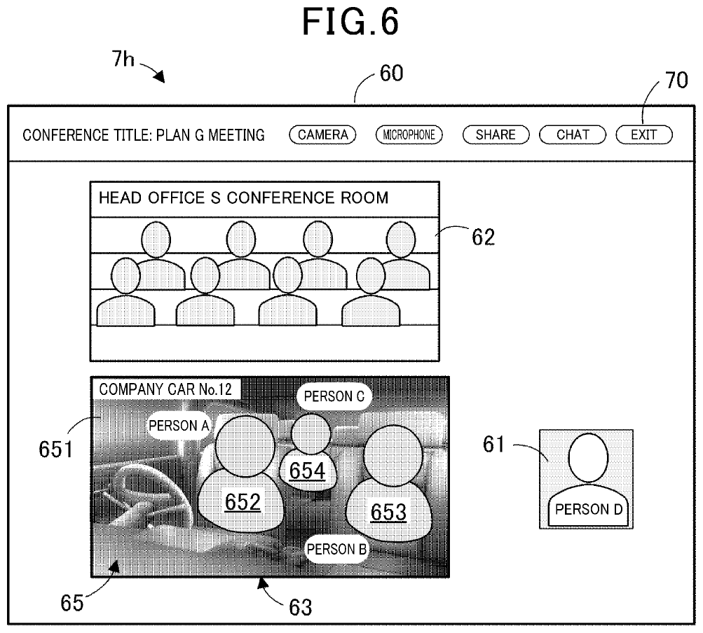

FIG. 6 is a diagram illustrating a second example of the interior image distributed by the distribution unit 26. Similarly to FIG. 5, FIG. 6 illustrates the screen of the participant display which is transmitted to the terminal device 7h of the conference participant Uh and displayed. Note that, in FIG. 6, components same as the components of the screen illustrated in FIG. 5 are indicated using signs same as the signs in FIG. 5, and explanation for FIG. 5 described above is applied.

In FIG. 6, an interior image 65 which is the second example of the interior image is displayed for the third participant display 63. In the interior image 65, a simple graphic display viewing the interior of the moving object corresponding to the attribute “5-seater passenger car” of the moving object 2 from front is used as an interior space image 651, and slightly three-dimensional occupant displays 652, 653 and 654 indicating each of the three mobile participants Um are superimposed and displayed at the corresponding positions of the respective mobile participants Um in the interior of the moving object 2. The occupant displays 652, 653 and 654 correspond to the conference participants Um1, Um2 and Um3 illustrated in FIG. 1, respectively.

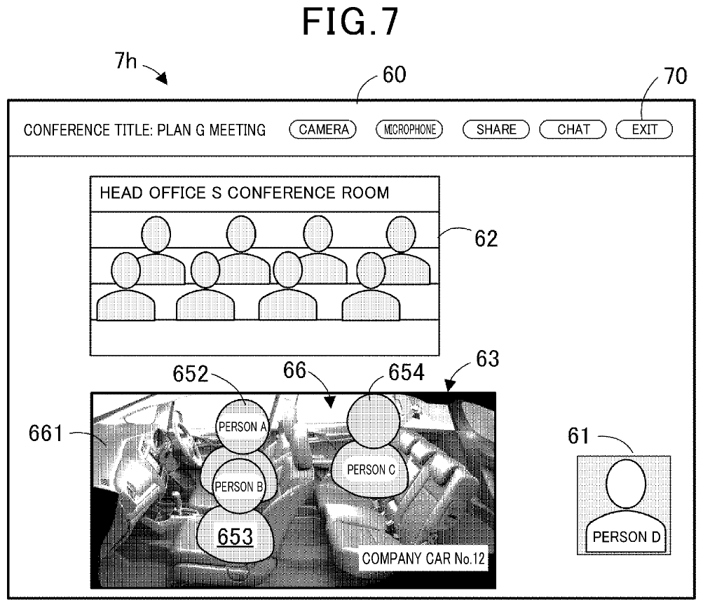

FIG. 7 is a diagram illustrating a third example of the interior image distributed by the distribution unit 26. Similarly to FIG. 5 and FIG. 6, FIG. 7 also illustrates the screen of the participant display which is transmitted to the terminal device 7h of the conference participant Uh and displayed. Note that, in FIG. 7, components same as the components of the screen illustrated in FIG. 5 or FIG. 6 are indicated using signs same as the signs in FIG. 5 or FIG. 6, and explanation for FIG. 5 or FIG. 6 described above is applied.

In FIG. 7, an interior image 66 which is the third example of the interior image is displayed for the third participant display 63. In the interior image 66, a more detailed graphic display viewing the interior of the moving object corresponding to the attribute “5-seater passenger car” of the moving object 2 from a side is used as an interior space image 661, and the occupant displays 652, 653 and 654 indicating each of the three mobile participants Um are superimposed and displayed at the corresponding positions of the respective mobile participants Um in the interior of the moving object 2.

The interior space image of the detailed graphic display like the interior space image 661 can be, for example, generated beforehand for every model of the moving object and stored in the first memory 21. When the detection unit 24 acquires attribute information including a specific model of the moving object 2, the generation unit 25 of the conference server 3 can select and use the interior space image corresponding to the model indicated by the above attribute information from the interior space images for every model stored in the first memory 21.

### [1.3 Configuration of Portable Terminal]

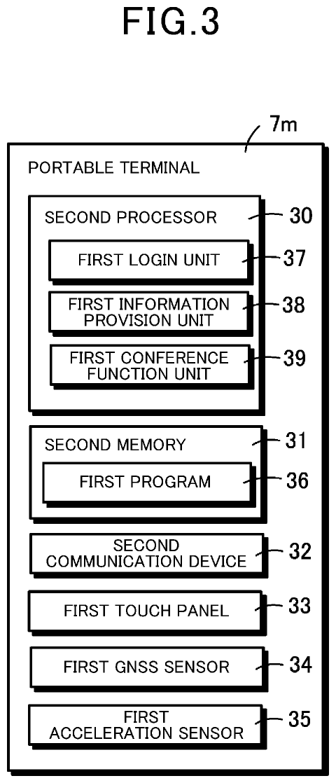

FIG. 3 is a diagram illustrating an example of the configuration of the portable terminal 7m.

The portable terminal 7m includes a second processor 30, a second memory 31, a second communication device 32, the first touch panel 33, a first GNSS (Global Navigation Satellite System) sensor 34, and a first acceleration sensor 35.

The second memory 31 is, for example, configured by a volatile and/or nonvolatile semiconductor memory. The second communication device 32 is a transmitter/receiver for the portable terminal 7m to wirelessly communicate with the external device such as the conference server 3 via the communication network 5.

The first touch panel 33 is controlled by the second processor 30, displays the information to a user and acquires input from the user. The first GNSS sensor 34 acquires position information for a current position of the portable terminal 7m. The first acceleration sensor 35 detects current acceleration applied to the portable terminal 7m.

The second processor 30 is a computer including a CPU or the like, for example. The second processor 30 may include a ROM in which a program is written, and a RAM for temporary storage of data, or the like. Then, the second processor 30 includes a first login unit 37, a first information provision unit 38, and a first conference function unit 39, as functional elements or functional units.

The functional elements provided in the second processor 30 are realized by the second processor 30 which is the computer executing a first program 36 preserved in the second memory 31, for example. Note that the first program 36 is, for example, an application program of the conference participation app, and the second processor 30 executes the first program 36 by an activation instruction from a user (the mobile participant Um for example. The same applies hereinafter) via the first touch panel 33. The first program 36 can be downloaded from a server device (not illustrated) connected to the communication network 5. In addition, the first program 36 can be stored in a computer-readable arbitrary storage medium.

The first login unit 37 transmits a login request to the conference server 3 using the setting information for the online conference transmitted from the conference server 3 beforehand by the activation instruction from the user via the first touch panel 33 according to the prior art. In addition, when transmitting the login request, the first login unit 37 outputs a message which urges the user to input the access information or the identification information for the moving object when participating in the online conference from the moving object via the first touch panel 33. When the user inputs the access information or the identification information for the moving object via the first touch panel 33, the first login unit 37 includes the input information in the above login request and transmits it to the conference server 3.

The first information provision unit 38 measures the current position of the portable terminal 7m and the acceleration applied to the portable terminal 7m by the first GNSS sensor 34 and the first acceleration sensor 35, and transmits them to the conference server 3 at a predetermined time interval, in response to reception of an information request from the conference server 3.

The first conference function unit 39 performs the conference operations predetermined as the operations required for the online conference with the conference server 3 using a non-illustrated microphone, a non-illustrated speaker, and the first touch panel 33 which are provided in the portable terminal 7m, according to the prior art. The conference operations include, for example, the transfer of the voice, the transfer of the conference material data and/or the transfer of the images. The above images may include the image of the above-described participant display distributed by the conference server 3. The first conference function unit 39 displays the received image of the participant display on the first touch panel 33.

### [1.4 Configuration of Mobile Terminal Device]

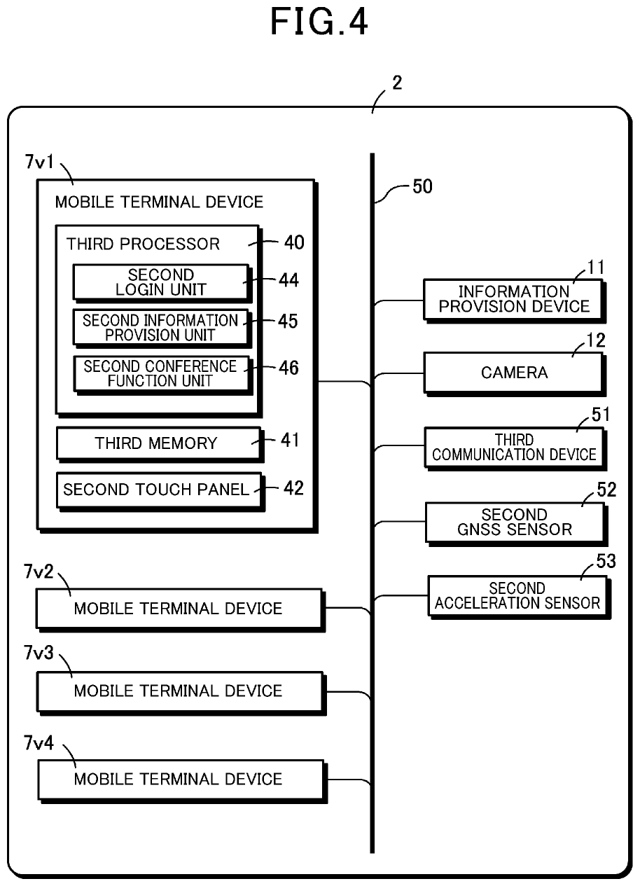

FIG. 4 is a diagram illustrating an example of the configuration of the mobile terminal device 7v loaded in the moving object 2. FIG. 4 illustrates the configuration of the mobile terminal device 7v1 as an example, however, the other mobile terminal devices 7v2, 7v3 and 7v4 also have the similar configuration.

Each of the mobile terminal devices 7v is communicably connected with the information provision device 11, the camera 12, the third communication device 51, a second GNSS sensor 52, and a second acceleration sensor 53 which are loaded in the moving object 2, via a communication bus 50 loaded in the moving object 2.

The third communication device 51 is a wireless communication device (transmitter/receiver) for the mobile terminal device 7v and the information provision device 11 to communicate with the conference server 3 via the communication network 5.

The second GNSS sensor 52 measures the position information for the current position of the moving object 2 and outputs it to the mobile terminal device 7v and the information provision device 11 at the predetermined time interval.

The second acceleration sensor 53 measures the acceleration applied to the moving object 2 and outputs it to the mobile terminal device 7v and the information provision device 11 at the predetermined time interval.

The mobile terminal device 7v includes a third processor 40, a third memory 41, and the second touch panel 42.

The third memory 41 is, for example, configured by a volatile and/or nonvolatile semiconductor memory.

The second touch panel 42 is controlled by the third processor 40, displays the information to the user and acquires the input from the user.

The third processor 40 is a computer including a CPU or the like, for example. The third processor 40 may include a ROM in which a program is written, and a RAM for temporary storage of data, or the like. Then, the third processor 40 includes a second login unit 44, a second information provision unit 45, and a second conference function unit 46, as functional elements or functional units.

The functional elements provided in the third processor 40 are realized by the third processor 40 which is the computer executing a program preserved in the third memory 41, for example. Note that the program can be stored in a computer-readable arbitrary storage medium.

The second login unit 44 transmits a login request to the conference server 3 using the setting information for the online conference transmitted from the conference server 3 beforehand by an activation instruction from the user via the second touch panel 42, according to the prior art.

In addition, when transmitting the login request, the second login unit 44 includes the access information or the identification information for the moving object 2 in the above login request and transmits it to the conference server 3. The access information or the identification information for the moving object 2 can be stored in the third memory 41 beforehand, or can be acquired from the information provision device 11 by the second login unit 44 at the time of login.

The second information provision unit 45 transmits the current position of the moving object 2 and the acceleration applied to the moving object 2 measured by the second GNSS sensor 52 and the second acceleration sensor 53 at the predetermined time interval to the conference server 3, in response to the reception of the information request from the conference server 3.

The second conference function unit 46 performs the transfer of the voice, the transfer of the conference material data and/or the transfer of the images which are the predetermined conference operations with the conference server 3 using a non-illustrated microphone, a non-illustrated speaker, and the second touch panel 42 which are provided in the mobile terminal device 7v, according to the prior art. The above images may include the image of the above-described participant display distributed by the conference server 3. The second conference function unit 46 displays the received image of the participant display on the second touch panel 42.

### [1.5 Processing in Conference Support System]

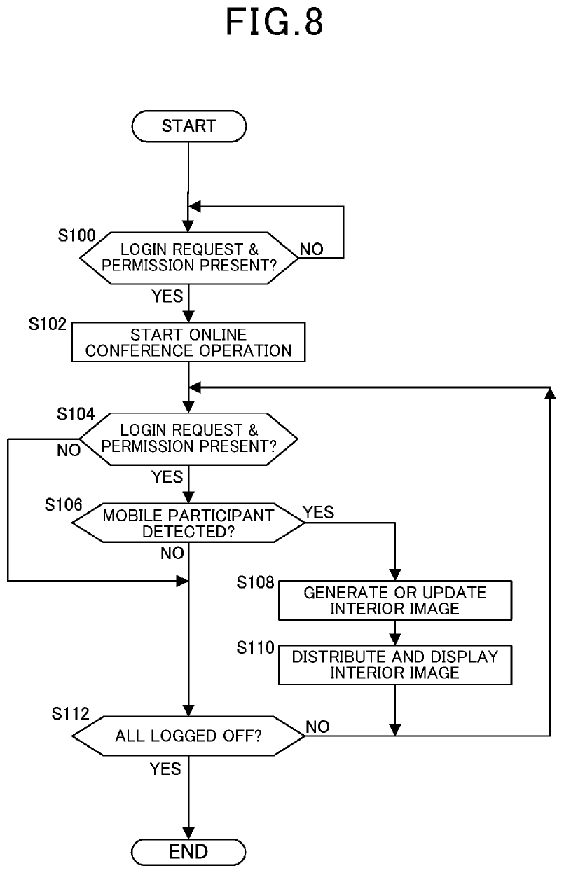

Next, a procedure of the operation of the conference support system 1 will be explained. FIG. 8 is a flowchart illustrating the procedure of a conference support method executed in cooperation by the computers of the conference support system 1. Here, the computers of the conference support system 1 may include the first processor 20 of the conference server 3, the second processor 30 of the portable terminal 7m, the third processor 40 of the mobile terminal device 7v, and the computer provided in the information provision device 11. Note that the processing illustrated in FIG. 8 is repeatedly executed. Prior to the processing in FIG. 8, the conference server 3 transmits the conference setting information to the terminal device of the conference organizer in response to the reception of the conference setting request for the online conference from the terminal device of the conference organizer, and the conference organizer transmits the conference holding notice including the conference setting information to the terminal devices 7 of the conference participants U to be invited to the online conference.

When the processing is started, first, the management unit 23 of the conference server 3 notifies the terminal device of the conference organizer when a login request is received from one of the terminal devices 7, and requests determination on whether or not to permit the login. Then, the management unit 23 determines whether or not the received login request is permitted (S100).

When the login request is not permitted (S100, NO), the management unit 23 returns to step S100 to repeat the processing, and repeats the reception of the login request and the determination of presence/absence of a login permission. On the other hand, when the login request is permitted (S100, YES), the distribution unit 26 starts the online conference operation (S102). The online conference operation is continued until it is determined that all the conference participants U have logged off in step S112.

Subsequently, the management unit 23 further performs the reception of a new login request and the determination of the presence/absence of the login permission (S104). Then, when the new login request is permitted (S104, YES), the detection unit 24 determines whether or not the mobile participants Um who participate in the online conference from the moving object 2 are detected (S106). That is, the detection unit 24 determines whether or not the plurality of occupants riding in the same moving object 2 is participating in the same online conference is detected. The detection can be performed by one of the methods (operations) described above for the detection unit 24.

Then, when the plurality of mobile participants Um who participate in the online conference from the moving object 2 are detected (S106, YES), the generation unit 25 generates the interior image indicating that the plurality of occupants, that is the mobile participants Um, participating in the online conference from the same moving object 2 are present in the same interior space of the moving object 2 (S108). Subsequently, the transmission unit 28 of the distribution unit 26 transmits the above generated interior image to the terminal devices 7 of the conference participants U participating in the online conference, and each terminal device 7 displays the interior image (S110). Thereafter, the distribution unit 26 returns the processing to step S104. By repetition of the processing of steps S104 to S110, every time a mobile participant Um newly logs in and the login is permitted, the occupant display of the new mobile participant Um is added and the interior image is updated.

On the other hand, when the detection unit 24 does not detect the mobile participants Um in step S106 (S106, NO), the management unit 23 determines whether or not a logoff request is received from the terminal devices 7 of all the above conference participants U who have logged in, according to the prior art (S112). The logoff request can be transmitted from the terminal device 7 to the conference server 3 by the conference participant U operating the exit button 70 (FIG. 5 or the like) on the online conference screen displayed at the terminal device 7, for example.

Then, when the logoff request is received from the terminal devices 7 of all the conference participants U who have logged in (S112, YES), the management unit 23 ends the present processing. On the other hand, when the logoff request is not received from the terminal devices 7 of all the conference participants U who have logged in (S112, NO), the management unit 23 returns to step S104 to repeat the processing.

Further, on the other hand, when the reception of the login request or the permission of the login request is not performed in step S104 (S104, NO), the management unit 23 moves the processing to step S112.

Here, step S106 in FIG. 8 corresponds to a detection step in the present disclosure. In addition, steps S108 and S110 correspond to a generation step and a transmission step in the present disclosure, respectively.

Note that the present invention is not limited to the configuration of the embodiment described above, and can be implemented in various modes without deviating from the gist.

### [2. Configurations Supported by Embodiment Described Above]

The embodiment described above supports the following configurations.

(Configuration 1) A conference support system including: a detection unit configured to detect that a plurality of occupants riding in a same moving object is participating in a same online conference; a generation unit configured to generate an interior image indicating that the plurality of occupants is present in a same interior space of the moving object; and a transmission unit configured to transmit the interior image to a terminal device of a conference participant participating in the online conference.

According to the conference support system of configuration 1, the plurality of conference participants who participate in the same online conference from the same moving object can be detected and the situation inside the moving object of the plurality of conference participants or the like can be reported to the other participants outside the moving object, thereby contributing to improvement of quality of communication among the conference participants in the online conference.

(Configuration 2) The conference support system according to configuration 1, wherein the generation unit generates the interior image by superimposing an occupant display indicating each of the plurality of occupants on an interior space image indicating the interior space of the moving object.

According to the conference support system of configuration 2, since the image of the interior space of the moving object is used for the interior image, the situation of the conference participants inside the moving object can be realistically reported to the other participants.

(Configuration 3) The conference support system according to configuration 1 or 2, wherein the detection unit specifies a position, in an interior of the moving object, of each of the plurality of occupants attending the online conference, and the generation unit generates the interior image by superimposing the occupant display indicating the occupant at the position corresponding to each of the plurality of occupants on the interior space image indicating the interior space of the moving object.

According to the conference support system of configuration 3, since the arrangement of the conference participants in the interior of the moving object can be recognized by the interior image, the other participants finely recognize the situation of the conference participants inside the moving object, and the quality of the communication in the conference can be improved.

(Configuration 4) The conference support system according to configuration 2 or 3, wherein the detection unit specifies an attribute of the moving object including a kind, a model, a seating capacity or a seat arrangement of the moving object, and the generation unit determines the interior space image to be used for the interior image based on the attribute of the moving object.

According to the conference support system of configuration 4, since the interior image can be expressed more realistically based on the attribute of the moving object, the other participants further finely recognize the situation of the conference participants inside the moving object, and the quality of the communication in the conference can be improved.

(Configuration 5) The conference support system according to any one of configurations 2-4, wherein the occupant display superimposed on the interior image is an icon or an image indicating a corresponding occupant.

According to the conference support system of configuration 5, the conference participants who participate from the moving object can be more realistically expressed.

(Configuration 6) The conference support system according to any one of configurations 1-5, wherein the detection unit determines a plurality of persons participating in the online conference from each of terminal devices loaded in the moving object as the plurality of occupants participating in the online conference from the moving object.

According to the conference support system of configuration 6, the conference participants who participate in the online conference from the same moving object can be easily detected.

(Configuration 7) The conference support system according to any one of configurations 1-5, wherein the detection unit acquires a current position of the moving object and a current position of each of terminal devices used for the online conference at a predetermined time interval, and determines persons who participate in the online conference using the terminal devices indicating a same position change as the moving object within a predetermined position error range as the plurality of occupants participating in the online conference from the moving object.

According to the conference support system of configuration 7, even when the moving object does not include the terminal device, the conference participants who participate in the online conference from the moving object can be easily detected.

(Configuration 8) The conference support system according to any one of configurations 1-5, wherein the detection unit acquires acceleration of the moving object and acceleration of each of terminal devices used for the online conference at a predetermined time interval, and determines persons who participate in the online conference using the terminal devices indicating a same acceleration change as the moving object within a predetermined error range as the plurality of occupants participating in the online conference from the moving object.

According to the conference support system of configuration 8, even when the moving object does not include the terminal device, the conference participants who participate in the online conference from the moving object can be easily detected.

(Configuration 9) The conference support system according to any one of configurations 1-5, wherein the detection unit detects the plurality of occupants who participates in the online conference from the moving object, based on an image from a camera which is loaded in the moving object and which photographs an interior of the moving object.

According to the conference support system of configuration 9, the conference participants who participate in the online conference from the same moving object can be easily detected.

(Configuration 10) The conference support system according to any one of configurations 1-5, wherein the detection unit acquires, from a terminal device of a person who participates in the online conference, information on the moving object that the person is riding when participating in the online conference.

According to the conference support system of configuration 10, the conference participants who participate in the online conference from the moving object can be easily detected.

(Configuration 11) A conference support method performed by a computer provided in a conference support system, the method including: a detection step of detecting that a plurality of occupants riding in a same moving object are participating in a same online conference; a generation step of generating an interior image indicating that the plurality of occupants is present in a same interior space of the moving object; and a transmission step of transmitting the interior image to a terminal device of a conference participant participating in the online conference.

According to the conference support method of configuration 11, the plurality of conference participants who participate in the same online conference from the same moving object can be detected and the situation inside the moving object of the plurality of conference participants or the like can be reported to the other participants outside the moving object, thereby contributing to the improvement of the quality of the communication among the conference participants in the online conference.

### REFERENCE SIGNS LIST

1 . . . conference support system, 2 . . . moving object, 3 . . . conference server, 5 . . . communication network, 6 . . . house, 7, 7h, 7g . . . terminal device, 7m, 7m1, 7m2, 7m3 . . . portable terminal, 7v, 7v1, 7v2, 7v3, 7v4 . . . mobile terminal device, 8 . . . conference location, 9, 12 . . . camera, 10, 60 . . . display device, 11 . . . information provision device, 20 . . . first processor, 21 . . . first memory, 22 . . . first communication device, 23 . . . management unit, 24 . . . detection unit, 25 . . . generation unit, 26 . . . distribution unit, 27 . . . reception unit, 28 . . . transmission unit, 30 . . . second processor, 31 . . . second memory, 32 . . . second communication device, 33 . . . first touch panel, 34 . . . first GNSS sensor, 35 . . . first acceleration sensor, 36 . . . first program, 37 . . . first login unit, 38 . . . first information provision unit, 39 . . . first conference function unit, 40 . . . third processor, 41 . . . third memory, 42 . . . second touch panel, 44 . . . second login unit, 45 . . . second information provision unit, 46 . . . second conference function unit, 50 . . . communication bus, 51 . . . third communication device, 52 . . . second GNSS sensor, 53 . . . second acceleration sensor, 61 . . . first participant display, 62 . . . second participant display, 63 . . . third participant display, 64, 65, 66 . . . interior image, 641, 651, 661 . . . interior space image, 642, 643, 644, 652, 653, 654 . . . occupant display, 70 . . . exit button, Um1, Um2, Um3, Uh . . . conference participant, Ug . . . participant group.

What is claimed is:

1. A conference support system comprising:
a detection unit configured to detect that a plurality of occupants riding in a same moving object is participating in a same online conference;
a generation unit configured to generate an interior image indicating that the plurality of occupants is present in a same interior space of the moving object; and
a transmission unit configured to transmit the interior image to a terminal device of a conference participant participating in the online conference.

2. The conference support system according to claim 1,
wherein the generation unit generates the interior image by superimposing an occupant display indicating each of the plurality of occupants on an interior space image indicating the interior space of the moving object.

3. The conference support system according to claim 1,
wherein the detection unit specifies a position, in an interior of the moving object, of each of the plurality of occupants attending the online conference, and
the generation unit generates the interior image by superimposing the occupant display indicating the occupant at the position corresponding to each of the plurality of occupants on the interior space image indicating the interior space of the moving object.

4. The conference support system according to claim 2,
wherein the detection unit specifies an attribute of the moving object including a kind, a model, a seating capacity or a seat arrangement of the moving object, and
the generation unit determines the interior space image to be used for the interior image based on the attribute of the moving object.

5. The conference support system according to claim 2, wherein the occupant display superimposed on the interior image is an icon or an image indicating a corresponding occupant.

6. The conference support system according to claim 1,
wherein the detection unit determines a plurality of persons participating in the online conference from each of terminal devices loaded in the moving object as the plurality of occupants participating in the online conference from the moving object.

7. The conference support system according to claim 1,
wherein the detection unit
acquires a current position of the moving object and a current position of each of terminal devices used for the online conference at a predetermined time interval, and
determines persons who participate in the online conference using the terminal devices indicating a same position change as the moving object within a predetermined position error range as the plurality of occupants participating in the online conference from the moving object.

8. The conference support system according to claim 1,
wherein the detection unit
acquires acceleration of the moving object and acceleration of each of terminal devices used for the online conference at a predetermined time interval, and
determines persons who participate in the online conference using the terminal devices indicating a same acceleration change as the moving object within a predetermined error range as the plurality of occupants participating in the online conference from the moving object.

9. The conference support system according to claim 1,
wherein the detection unit detects the plurality of occupants who participates in the online conference from the moving object, based on an image from a camera which is loaded in the moving object and which photographs an interior of the moving object.

10. The conference support system according to claim 1,
wherein the detection unit acquires, from a terminal device of a person who participates in the online conference, information on the moving object that the person is riding when participating in the online conference.

11. A conference support method performed by a computer provided in a conference support system, the method comprising:
a detection step of detecting that a plurality of occupants riding in a same moving object is participating in a same online conference;
a generation step of generating an interior image indicating that the plurality of occupants is present in a same interior space of the moving object; and
a transmission step of transmitting the interior image to a terminal device of a conference participant participating in the online conference.
